(19) United States
(12) Patent Application Publication
(10) Pub. No.: US 2026/0058329 A1
(43) Pub. Date: Feb. 26, 2026

(54) BATTERY CELL WITH INTEGRATED OVERCURRENT PROTECTION MEMBER

(71) Applicant: TECHTRONIC CORDLESS GP, Anderson, SC (US)

(72) Inventors: Dan GENG, Dongguan City (CN); Denis Gaston FAUTEUX, Hong Kong (CN); Jin Wei LI, Dongguan City (CN); Chi LIANG, Dongguan City (CN)

(21) Appl. No.: 19/104,867

(22) PCT Filed: Sep. 14, 2022
(86) PCT No.: PCT/CN2022/118615

§ 371 Date: Feb. 19, 2025

(51) Int. Cl. H01M 50/533; H01M 50/107; H01M 50/548; H01M 50/583

(52) U.S. Cl. CPC H01M 50/533; H01M 50/107; H01M 50/548; H01M 50/583; H01M 2200/103

(57) ABSTRACT

A battery cell includes a housing (14), a terminal (30) coupled to the housing (14), an electrode assembly (18) positioned within the housing (14), a conductor (38) including a first portion (74) coupled to the electrode assembly (18) and a second portion (78) coupled to the terminal (30), and one or more fuses coupled to the conductor (38) and situated at least partially between the first and second portions. The first and second portions of the conductor (38) are folded in opposite directions to form the conductor into an S-shape, and the one or more fuses are rated for interrupting current flow between the terminal (30) and the electrode assembly (18) in response to an overcurrent event.

### FIELD

The present disclosure relates generally to battery cells. More particularly, the present disclosure relates battery cell current collectors having over-current protection functionality.

### BACKGROUND

Batteries are critical in providing power to many electrical devices that are relied upon daily. Cylindrical batteries with a rolled arrangement (i.e., jelly roll battery cells) are commonly used to power electrical devices. A rolled cylindrical battery generally includes an electrode assembly comprising an anode, a separator, and a cathode cylindrically rolled together in concentric layers and placed into a battery housing with electrical terminals provided at either end of the housing. Typical battery cells, and particularly tabless battery cells often include a current collector or weld plate as bridging components that provide electrical connection between the electrode assembly and a corresponding battery terminal. Multiple cylindrical battery cells are often arranged together in an assembly for form a battery pack, such as a removable battery pack for power tools, vehicles, other handheld devices, and the like.

### SUMMARY

One aspect of the present discloser provides a battery cell housing including a first end and a second end opposite the first end, a first terminal coupled to the housing adjacent the first end, an electrode assembly positioned within the housing between the first end and the second end, the electrode assembly including an anode, a cathode, and one or more separator sheets, the electrode assembly further including a rubbing portion at a first end of one of the anode and the cathode, and a formable conductor configured to electrically couple the rubbing portion and the first terminal. The conductor includes a first connector portion coupled to the rubbing portion, a second connector portion coupled to the first terminal, a first fold region, a second fold region, and a narrowed portion extending between the first and second fold regions, the narrowed portion configured to interrupt a current flow between the rubbing portion and the first terminal in response to the current flow exceeding a predetermined value.

Another aspect of the present discloser provides a method of connecting electrical elements of a battery cell, the method including positioning an electrode assembly within a housing of the battery cell, rubbing the electrode assembly to create a rubbing portion, connecting a first end of a formable conductor to the rubbing portion, the conductor including a body rated for a first amount of current flow, narrowing a portion of the body to form a narrowed portion rated for a second amount of current flow that is less than the first amount, folding the conductor in a first direction about a first fold region positioned on a first side of the narrowed portion, folding the conductor in a second direction, toward the narrowed portion, about a second fold region positioned on a second side of the narrowed portion, such that the narrowed portion extends between the first and second fold regions, and connecting a second end of the formable conductor to a terminal coupled to the housing. The narrowed portion is configured to interrupt current flow between the rubbing portion and the terminal in response to the current flow exceeding the second amount of current flow.

Still another aspect of the present disclosure provides a battery cell including a housing, a terminal coupled to the housing, an electrode assembly positioned within the housing, a conductor including a first portion coupled to the electrode assembly and a second portion coupled to the terminal, the first and second portions folded in opposite directions to form the conductor into an S-shape, and one or more fuses coupled to the conductor and situated at least partially between the first and second portions, the one or more fuses rated for interrupting current flow between the terminal and the electrode assembly in response to an overcurrent event.

Other aspects of the present disclosure will become apparent by consideration of the detailed description and accompanying drawings.

### BRIEF DESCRIPTION OF THE DRAWINGS

FIG. 1 is an exploded perspective view of a battery cell, according to an embodiment of the present disclosure.

FIG. 2 is a plan view of a current collection plate, according to one example construction, useable with the battery cell of FIG. 1, illustrating the plate in an un-formed condition.

FIG. 3 is a perspective view of the current collection plate of FIG. 2, illustrating the plate in a formed condition.

FIG. 4 is a cross-sectional perspective view of the current collection plate of FIG. 3, formed and positioned in the battery cell, taken along section A-A of FIG. 1.

FIG. 5 is a plan view of a current collection plate, according to another example construction, useable with the battery cell of FIG. 1, illustrating the plate in an un-formed condition.

FIG. 6 is a perspective view of the current collection plate of FIG. 5, illustrating the plate in a formed condition.

FIG. 7 is a cross-sectional perspective view of the current collection plate of FIG. 6, formed and positioned in the battery cell, taken along section A-A of FIG. 1.

FIG. 8 is a top plan view of a current collection plate, according to another example construction, useable with the battery cell of FIG. 1, illustrating possible dimensions of the plate.

FIG. 9 is a side plan view of the current collection plate of FIG. 8.

FIG. 10 is a top plan view of a current collection plate, according to another example construction, useable with the battery cell of FIG. 1.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

### DETAILED DESCRIPTION

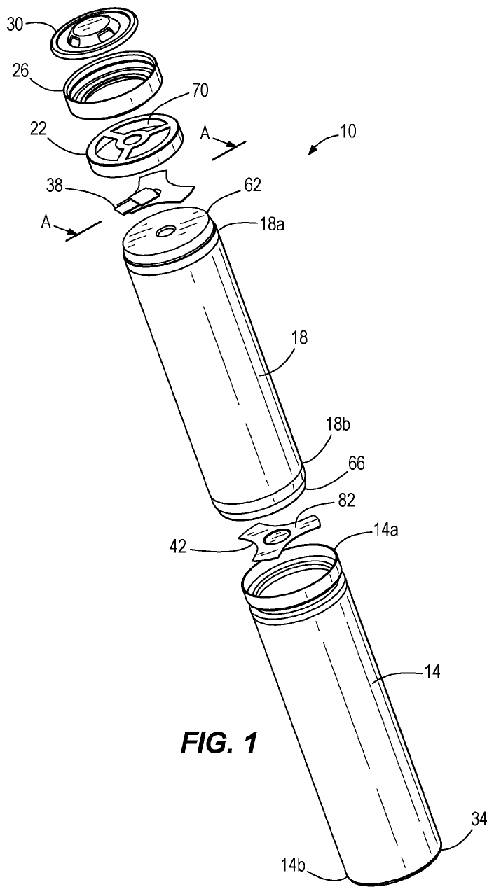

FIG. 1 illustrates a battery cell 10 according to some embodiments. The battery cell 10 includes a housing 14, an electrode assembly 18 positioned within the housing 14, a first insulating member 22, and a second insulating member 26. The battery cell 10 further includes a first terminal 30 positioned at a first end 14a of the housing 14, a second terminal 34 positioned at a second end 14b of the housing 14, a first conductor 38 positioned in the housing 14 between the electrode assembly 18 and the first terminal 30, and a second conductor 42 positioned in the housing 14 between the electrode assembly 18 and the second terminal 34. In the illustrated embodiment, the first conductor 38 is a formable (e.g., bendable, malleable, manipulatable, etc.) current collection plate, current collector, and/or the like that is configured to electrically couple the electrode assembly 18 to the first terminal 30.

As illustrated in FIG. 1, the housing 14 generally provides a casing for the electrical elements (e.g., electrode assembly 18, first terminal 30, second terminal 34, first conductor 38, second conductor 42, and/or the like) of the battery cell 10. In some embodiments, some or all of the electrical elements are seated within the housing 14. In the illustrated embodiment, the housing 14 is be made of an insulative material, such as plastic or another non-conductive material. In some embodiments, the housing 14 may be made of a conductive material, such as steel, aluminum, or another conductive metal. In some embodiments, the housing 14 functions as a negative terminal to facilitate an external connection for the battery cell 10. For example, the second terminal 34 may be integrated into the housing 14 at the second end 14b.

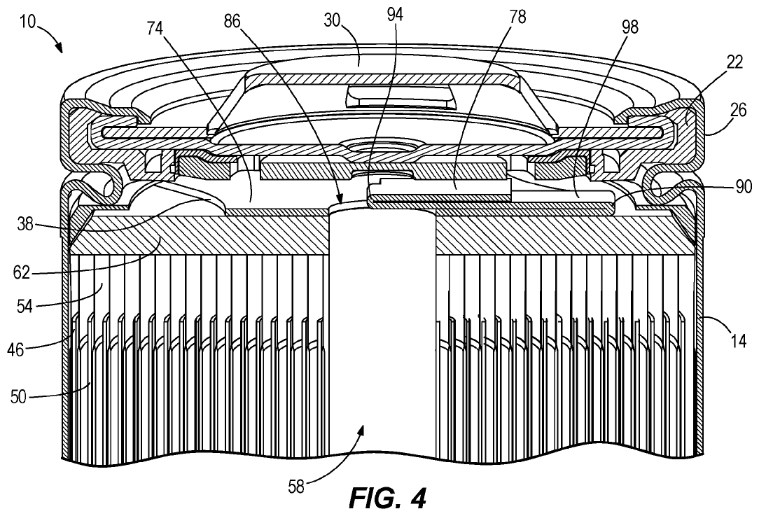

With continued reference to FIG. 1 and brief reference to FIG. 4, the electrode assembly 18 includes an anode 46, a cathode 50, and one or more separators 54 positioned between the anode 46 and the cathode 50. In the illustrated embodiment, the anode 46 includes an anode sheet, the cathode 50 includes a cathode sheet, and the separator 54 includes an insulator or separator sheet. As shown in FIG. 4, the sheets may be rolled in concentric layers about a central aperture 58 of the electrode assembly 18 to form a jelly roll. In some embodiments, the electrode assembly 18 is wound around a center pin which may be removed after completion of the winding operation.

Once wound, a first end 18a and a second end 18b of the electrode assembly 18 may include exposed or uncoated portions of the anode 46 and the cathode 50. The exposed portions at the first end 18a may be rubbed down to a flat, rough surface to form a first rubbing portion 62, and the exposed portions at the second end 18b may be rubbed down to a flat, rough surface to form a second rubbing portion 66. The first rubbing portion 62 provides a landing surface for the first conductor 38 such that the first conductor 38 may be coupled (e.g., welded, affixed, adhered, fastened, etc.) to the electrode assembly 18. Similarly, the second rubbing portion 66 provides a connection for the second conductor 42.

In some embodiments, the electrode assembly 18 may have a nominal voltage between approximately I V and approximately 5 V, and a nominal capacity between about 1 Ah and about 5 Ah or more (e.g., up to about 9 Ah). The electrode assembly 18 may have any rechargeable chemistry type, such as, for example Lithium (“Li”), Lithium-ion (“Li-ion”), other Lithium-based chemistry, Nickel-Cadmium (“NiCd”), Nickel-metal Hydride (“NiMH”), etc. In the illustrated embodiment, the first terminal 30 is a positive terminal and the second terminal 34 is a negative terminal.

In some embodiments, the first insulating member 22 is made of plastic and/or rubber. The first insulating member 22 may provided with through holes 70 that allow the first conductor 38 to extend through the first insulating member 22 and contact the first terminal 30. As shown in FIG. 4, the first rubbing portion 62 may be arranged or seated in the first insulating member 22 to prevent contact between the first rubbing portion 62 and the housing 14. The first terminal 30 may then be arranged in the second insulating member 26 that is supported on the first insulating member 22. In some embodiments, the first insulating member 22 and the second insulating member 26 are crimped over the first terminal 30 once the electrode assembly 18 and other electrical elements are arranged in the housing 14.

Referring still to FIG. 1, the first terminal 30 may provide electrical contact to an external device in order to provide electrical power to the external device from the electrode assembly 18. In the illustrated embodiment, the first terminal 30 may receive power from an external device to recharge the electrode assembly 18. In some embodiments, the first terminal 30 is a positive terminal electrically connected to positive electrode sheet (e.g., anode 46) within the electrode assembly 18, and the second terminal 34 is a negative terminal connected to a negative sheet (e.g., cathode 50). For example, the first terminal 30 may connect the anode 46 of the electrode assembly 18 to a positive terminal of an external device that is to be powered by the battery cell 10. In some embodiments, the first terminal 30 is made of metal, such as stainless steel.

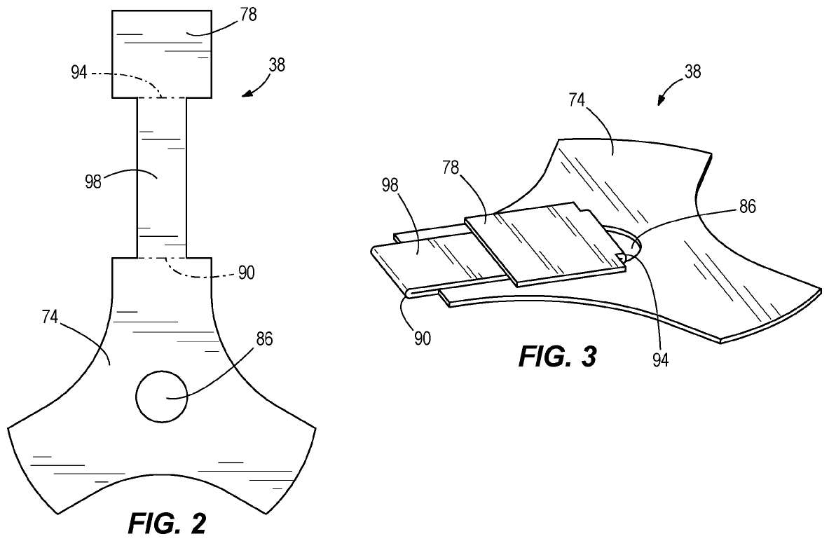

Referring now to FIGS. 2-4, the first conductor 38 includes a first connector portion 74 and a second connector portion 78 each in the form of a welding plate. The first connector portion 74 is coupled to the first end 18a of the electrode assembly 18. In the illustrated embodiment, the first connector portion 74 is welded to the first rubbing portion 62 by laser welding, spot welding, ultrasonic welding, and/or the like. The first conductor 38 is therefore configured to communicate a current flow between the first rubbing portion 62 and the first terminal 30. In some embodiments, the first conductor 38 may be formed of aluminum, nickel, copper, and/or another conductive material. The second conductor 42 may also include a connector portion 82 in the form of a welding plate coupled to the second rubbing portion 66 to electrically communicate current flow between the second terminal 34 and the second end 18b of the electrode assembly 18. Similar to the first conductor 38, the second conductor 42 may be formed of aluminum, nickel, copper, and/or another conductive material.

Referring now to FIG. 2, the first conductor 38 further includes an aperture 86 arranged coaxially with the central aperture 58 of the electrode assembly 18, a first fold region 90, a second fold region 94, and a narrowed portion 98 situated at least partially between the first fold region 90 and the second fold region 94. The first connector portion 74 and the second connector portions 78 may have a first dimension defining a first current rating, and the narrowed portion 98 may have a second dimension defining a second current rating. The second dimension may be less than the first dimension, and the second current rating may be less than the first current rating. As best illustrated in FIG. 2, the first fold region 90 is positioned on a first side of the narrowed portion 98, and the second fold region 94 is positioned on a second, opposite side of the narrowed portion 98, such that the narrowed portion 98 at least partially extends between the first fold region 90 and the second fold region 94.

Accordingly, the narrowed portion 98 may form an overcurrent protection device, such as a fuse, integrally formed with the first conductor 38, such that the narrowed portion 98 may interrupt the current flow between the first rubbing portion 62 and the first terminal 30 in response to the current flow exceeding a predetermined value. For example, the narrowed portion 98 of the first conductor 38 may melt when the current flow exceeds the predetermined value (e.g., the current rating of the material forming the narrowed portion 98). In one example, the predetermined value may be 120% of the nominal current rating of the battery cell. However, values of more than 120% or less than 120% of the nominal rating are also contemplated.

Referring now to FIGS. 3 and 4, the first connector portion 74 and the second connector portion 78 may be folded in opposite directions to form the first conductor 38 into an S-shape. For example, FIG. 3 illustrates a perspective view of the first conductor 38, in which the first conductor 38 is in a formed condition. As shown in FIGS. 3 and 4, the narrowed portion 98 of the first conductor 38 is folded in a first direction (e.g., toward the first connector portion 74) about the first fold region 90, through approximately 180 degrees, and the second connector portion 78 is folded in a second direction (e.g., opposite the first direction, toward the narrowed portion 98) about the second fold region 94, through approximately 180 degrees. In some embodiments, the first conductor 38 is foldable about the first fold region 90 and the second fold region 94 through more or less than 180 degrees.

In the illustrated embodiment, the first fold region 90 and the second fold region 94 each have a bend radius and/or tolerance that allows the first conductor 38 to be deformed into the S-shape. In other embodiments, the first conductor 38 is molded into the S-shape rather than being folded. In some embodiments, the first fold region 90 and the second fold region 94 are positioned within the narrowed portion 98, such that the narrowed portion 98 itself is formed into the S-shape (e.g., folded in multiple directions). In some embodiments, the narrowed portion 98 can be provided with insulation (e.g., insulation coating or thin insulation tape) on at least one of its surfaces. Such insulation is utilized to inhibit short circuits between the narrowed portion 98 and the first and second connector portions 74, 78, even when these three portions are folded into the S-shape.

Referring specifically to FIG. 4, the first conductor 38 is formed into the S-shape and positioned in the battery cell 10 between the electrode assembly 18 and the first terminal 30. The first connector portion 74 of the first conductor 38 is coupled to the first rubbing portion 62 of the electrode assembly 18, and the second connector portion 78 of the first conductor 38 is coupled to the first terminal 30. The aperture 86 of the first connector portion 74 is positioned coaxially with the central aperture 58 of the electrode assembly 18. The first connector portion 74 is folded in the first direction about the first fold region 90 and the second connector portion 78 is folded in the second direction about the second fold region 94, so that the first connector portion 74 and the second connector portion 78 overlap one another in a longitudinal direction of the battery cell 10 to thereby form the S-shape.

During an overcurrent event (e.g., when current flow exceeds a predetermined value), the narrowed portion 98 and the first connector portion 74 and the second connector portion 78 heat up as the current flow increases. The first connector portion 74 and the second connector portion 78 are rated to reach a higher heat than the narrowed portion 98, such that the narrowed portion 98 provides a limiting current flow member (e.g., a fuse). That is, the max current flow through the first conductor 38 is equal to the max current flow through the narrowed portion 98. Once the current flow exceeds the max current flow of the narrowed portion 98, the narrowed portion 98 melts or otherwise separates to from an air gap in the first conductor 38 and interrupt current flow between the first rubbing portion 62 and the first terminal 30. In other words, the first connector portion and the second connector portion 78 of the first conductor 38 have the first dimension defining the first current rating, and the narrowed portion 98 of the first conductor 38 has the second dimension defining the second current rating, such that the second dimension is less than the first dimension, and the second current rating is less than the first current rating.

Referring back to FIGS. 1-4, one method for creating the battery cell 10 and/or connecting the electrical elements of the battery cell 10 includes rubbing the first end 18a of the electrode assembly 18 to create the first rubbing portion 62 and positioning the electrode assembly 18 within the housing 14. After creating the first rubbing portion 62, the first connector portion 74 of the first conductor 38 may be connected to the first rubbing portion 62. The narrowed portion 98 can be formed by narrowing (e.g., reducing the area of) some of the first conductor 38 to create a fuse rated for less current flow than remaining parts of the first conductor 38. For example, a body of the first conductor 38 may be narrowed to form the narrowed portion 98. The second connector portion 78 may then be connected to the first terminal 30 (e.g., though soldering, welding, etc.). The first conductor 38 may then be folded in the first direction about the first fold region 90 and then folded in the second direction about the second fold region 94. The first terminal 30 is then secured within and/or coupled to the housing 14. In other embodiments, the first connector portion 74 and the second connector portion 78 may be connected to the electrode assembly 18 and the first terminal 30 before the first conductor 38 is folded.

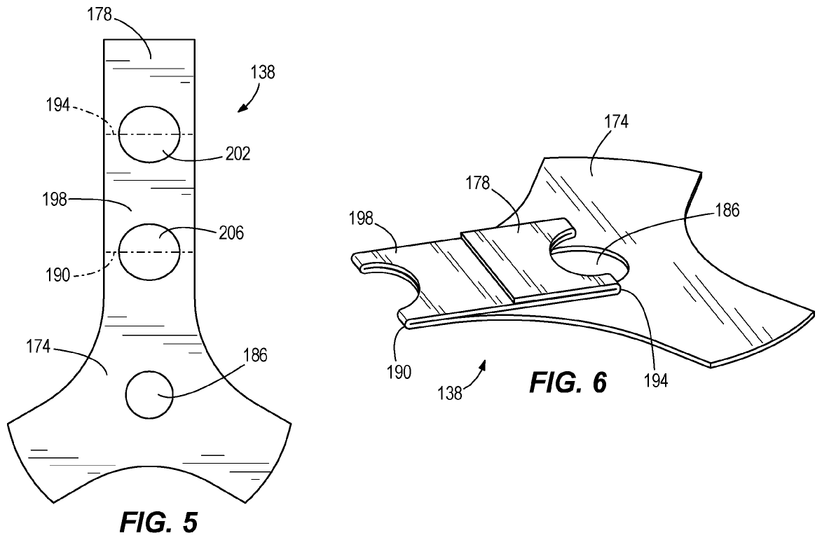

Referring now to FIGS. 5-7, the battery cell 10 may include a first alternate first conductor 138 useable with the battery cell 10 of FIG. 1 in place of or in addition to the first conductor 38 of FIGS. 1-4. Similar aspects between the first conductor 38 and the first alternate first conductor 138 are identified with common reference numbers plus “100.” Some of the differences between the first conductor 38 and the alternate first conductor 138 are described.

As illustrated in FIG. 5, the first alternate first conductor 138 includes a first aperture 202 and a second aperture 206 integrally formed in a body of the first alternate first conductor 138 between the first connector portion 174 and the second connector portion 178. In the illustrated embodiment, the first aperture 202 and the second aperture 206 are positioned at least partially between the first fold region 190 and the second fold region 194. In some embodiments, the first aperture 202 and the second aperture 206 form one or more narrowed portions 198. In other embodiments, the first aperture 202 and the second aperture 206 are situated centrally in the first alternate first conductor 138, and the narrowed portions 198 are formed between edges of the first aperture 202 and the second aperture 206 and edges or edge surfaces of the first alternate first conductor 138. In the illustrated embodiment, one or more of the narrowed portions 198 provide the fuses configured to interrupt current flow between the first terminal 30 and the electrode assembly 18. In some embodiments, one or more fuses are coupled to the narrowed portions 198.

Although the first aperture 202 and the second aperture 206 are illustrated, the number of apertures forming the narrowed portions is not limited to two and can be less than two or greater than two. For example, the first alternate first conductor 138 may include one aperture situated at least partially between the first fold region 190 and the second fold region 194, or three apertures situated at least partially between the first fold region 190 and the second fold region 194.

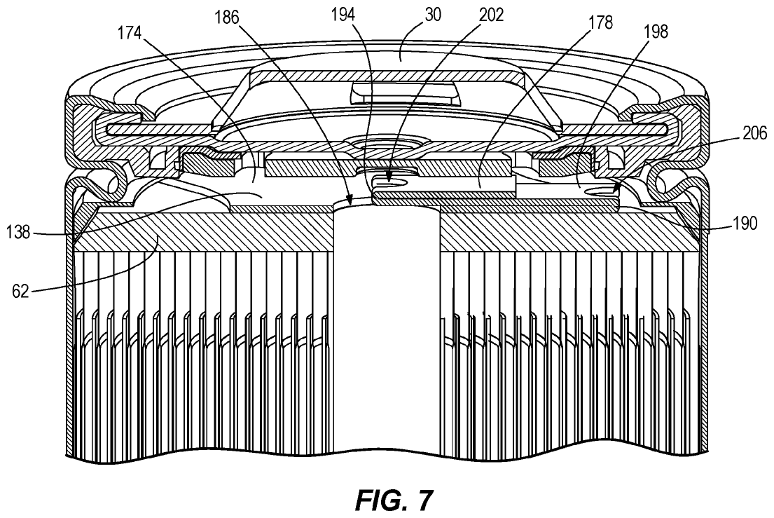

Referring now to FIGS. 6 and 7, the first alternate first conductor 138 is formed into the S-shape and positioned in the battery cell 10 between the first rubbing portion 62 and the first terminal 30. In the illustrated embodiment, the narrowed portion 198 is folded in the first direction, relative to the first connector portion 174, about the first fold region 190, and the second connector portion 178 is folded back about the second fold region 194. In the illustrated embodiment, the first aperture 202 and the second aperture 206 are foldable in the S-shape to align with one another and/or with the aperture 186 of the first alternate first conductor 138. In other embodiments, the first aperture 202 and the second aperture 206 do not align with the aperture 186 when folded (e.g., formed). In some embodiments, the first aperture 202, the second aperture 206, and the aperture 186 can all be arranged to align with the central aperture 58 of the electrode assembly 18.

As illustrated in FIG. 7, the first connector portion 174 of the first alternate first conductor 138 is coupled to the first rubbing portion 62 of the electrode assembly 18, and the second connector portion 178 is coupled to the first terminal 30. While in the formed condition (e.g., in the S-shape), portions of the first connector portion 174 and portions of the second connector portion 178 overlap one another in the longitudinal direction to form the conductor into the S-shape. The first aperture 202, the second aperture 206, and/or the narrowed portions 198 provide the fuse portions, which are configured to break and/or interrupt current flow from the electrode assembly 18 to the first terminal 30 to effectively disable the battery cell 10. In other words, the first conductor 38 and the first alternate first conductor 138 are each configured to provide an internal fuse coupled to a folded portion thereof. Thus, embodiments described herein provide, among other things, a fuse internal to a battery cell and formed on a formable conductive body between an electrode assembly and an output terminal.

In some embodiments, the narrowed portion 198 can be provided with insulation (e.g., insulation coating or thin insulation tape) on at least one of its surfaces. Such insulation is utilized to inhibit short circuits between the narrowed portion 198 and the first and second connector portions 174, 178, even when these three portions are folded into the S-shape.

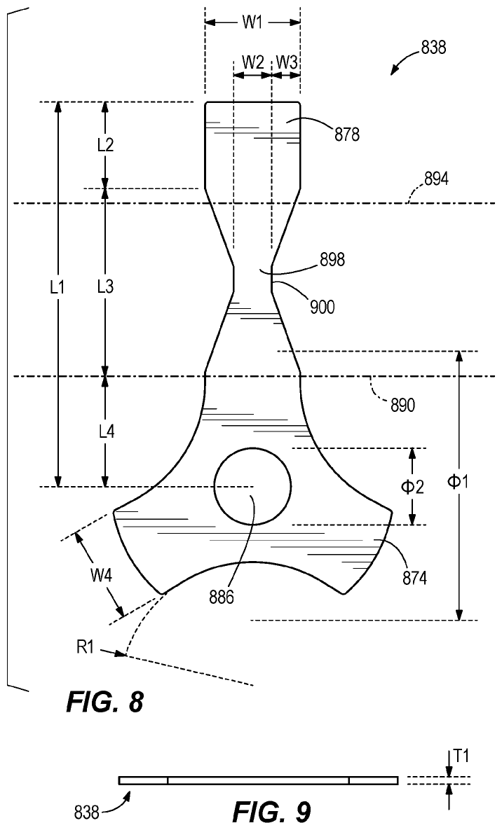

Referring now to FIGS. 8-9, the battery cell 10 may include a second alternate first conductor 838 useable with the battery cell 10 of FIG. 1 in place of, or in addition to, the first conductor 38 of FIGS. 1-4 and/or the first alternate first conductor 138 of FIGS. 5-7. Similar aspects between the first conductor 38 and the second alternate first conductor 838 are identified with common reference numbers plus “800.” For example, the second alternate first conductor 838 may include a first connector portion 874, a second connector portion 878, an aperture 886, a first fold region 890, a second fold region 894, and a narrowed portion 898.

FIGS. 8 and 9 also illustrate possible dimensions of the second alternate first conductor 838. While the dimensions described herein reference aspects and reference numbers for the second alternate first conductor 838 of FIGS. 8 and 9, is should be understood that the similar aspects between the first conductor 38 of FIGS. 1-4 and the alternate first conductor 138 of FIGS. 5-7 may have similar dimensions.

With continued reference to FIG. 8, the second alternate first conductor 838 may include a set of lengths L1, L2, L3, L4. The length L1 is defined between a distal or terminating edge of the second connector portion 878 and a center of the aperture 886. In some embodiments, the length L1 is between approximately 20.00 millimeters (mm) and approximately 30.00 mm (e.g., approximately 25.50 mm).

The length L2 is defined between the terminating edge of the second connector portion 878 and the second fold region 894. In some embodiments, the length L2 is between approximately 2.00 mm and approximately 8.00 mm (e.g., approximately 5.50 mm).

The length L3 is defined between the first fold region 890 and the second fold region 894 (e.g., the length of the narrowed portion 898). In some embodiments, the length L3 is between approximately 10.00 mm and approximately 15.00 mm (e.g., approximately 12.50 mm). In some embodiments, the length L3 may be approximately half of the length L1.

The length L4 is defined between the center of the aperture 886 and the first fold region 890. In some embodiments, the length L4 is between approximately 5.00 mm and approximately 10.00 mm (e.g., approximately 7.50 mm). In some embodiments, the combined distance of the length L2 and the length L3 may be approximately equal to the length L1, and the length L4 may be approximately equal to or greater than the length L2.

The second alternate first conductor 838 may further include a set of widths W1, W2, W3, W4. In some embodiments, the width W1 of the second connector portion 878 is between approximately 4.00 mm and approximately 8.00 mm (e.g., approximately 6.00 mm).

The width W2 is defined at a minimum width point of the narrowed portion 898. In some embodiments, the width W2 is between approximately 0.50 mm and approximately 6.00 mm (e.g., approximately 3.00 mm). In some embodiments, the narrowed portion 898 has an hourglass shape with a maximum width approximately the width W1 and a minimum width approximately the width W2. In the illustrated embodiment, the minimum width W2 may be measured at a tapered portion 900.

The width W3 may generally be defined as the difference between the width W1 and the width W2. In some embodiments, the width W3 is between approximately 0.25 mm and approximately 3.00 mm (e.g., approximately 1.50 mm).

The first connector portion 874 may have outer edges having a width W4. In the illustrated embodiment, the first connector portion 874 has three outer edges defined by the width W4 and separated by an arc (e.g., length between two outer edges) having a radius R1. In some embodiments, the width W4 is between approximately 3.00 mm and approximately 10.00 mm (e.g., approximately 6.00 mm). In some embodiments, the radius R1 is between approximately 4.00 mm and approximately 12.00 mm (e.g., approximately 8.00 mm).

A portion of or all of the first connector portion 874 may have a total length Φ1 defined between a center of one of the arcs and a portion of the narrowed portion 898. In some embodiments, the length Φ1 is between approximately 15.00 mm and approximately 23.00 mm (e.g., approximately 19.00 mm).

The aperture 886 of the second alternate first conductor 838 may have a diameter Φ2. In some embodiments, the diameter Φ2 is between approximately 2.50 mm and approximately 7.50 mm (e.g., approximately 5.00 mm).

As illustrated in FIG. 9, the second alternate first conductor 838 may also have a thickness T1. In some embodiments, the thickness T1 is between approximately 0.05 mm and approximately 0.80 mm (e.g., approximately 0.20 mm).

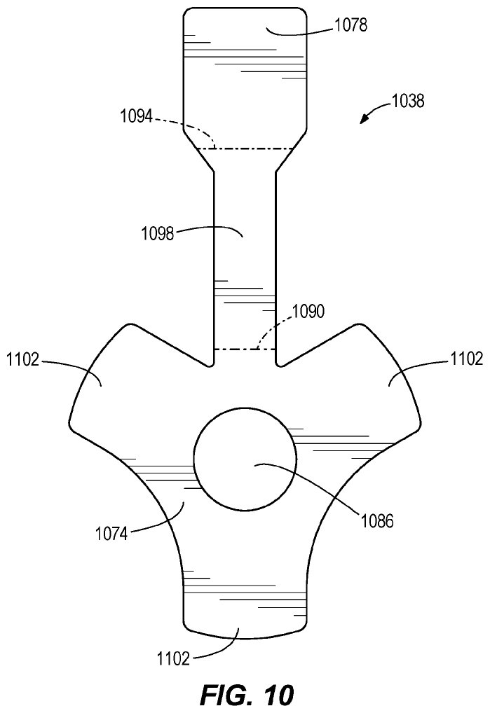

Referring now to FIG. 10, the battery cell 10 may include a third alternate first conductor 1038 useable with the battery cell 10 of FIG. 1 in place of or in addition to the first conductor 38 of FIGS. 1-4, the first alternate first conductor 138 of FIGS. 5-7, and/or the second alternate first conductor 838 of FIGS. 8-9. Similar aspects between the first conductor 38 and the third alternate first conductor 1038 are identified with common reference numbers plus “1000.” For example, the third alternate first conductor 1038 may include a first connector portion 1074, a second connector portion 1078, an aperture 1086, a first fold region 1090, a second fold region 1094, and a narrowed portion 1098. In some embodiments, the first connector portion 1074 of the third alternate first conductor 1038 may include three outer edges 1102 each separated by at least one arc. The narrowed portion 1098 may extend from between two adjacent outer edges 1102. In some embodiments, the width of the narrowed portion 1098 at least partially tapers between the second connector portion 1078 and the first connector portion 1074. Although aspects of the present disclosure have been described in detail with reference to certain embodiments, variations and modifications exist within the scope and spirit of one or more independent aspects as described. For example, the first conductor 38, the first alternate first conductor 138, the second alternate first conductor 838, and the third alternate first conductor 1038 are not limited to the dimensions described above and may have dimensions greater than or less than those described in reference to FIGS. 8 and 9. Various features of the disclosure are set forth in the following claims.

1. A battery cell comprising:
a housing including a first end and a second end opposite the first end:
a first terminal coupled to the housing adjacent the first end:
an electrode assembly positioned within the housing between the first end and the second end, the electrode assembly including an anode, a cathode, and one or more separator sheets, the electrode assembly further including a rubbing portion at a first end of one of the anode and the cathode; and
a formable conductor configured to electrically couple the rubbing portion and the first terminal, the conductor including:
a first connector portion coupled to the rubbing portion,
a second connector portion coupled to the first terminal,
a first fold region,
a second fold region, and
a narrowed portion extending between the first and second fold regions, the narrowed portion configured to interrupt a current flow between the rubbing portion and the first terminal in response to the current flow exceeding a predetermined value.

2. The battery cell of claim 1, wherein the formable conductor is a current collection plate.

3. The battery cell of claim 1, wherein the first connector portion includes outer edges, and the narrowed portion extends from between two adjacent outer edges.

4. The battery cell of claim 2, wherein the current collection plate includes an aperture coaxial with a central aperture of the electrode assembly.

5. The battery cell of claim 1, wherein the narrowed portion forms a single fuse integrally formed on the conductor between the first and second fold regions.

6. The battery cell of claim 1, wherein the conductor includes one or more apertures, and wherein the one or more apertures form the narrowed portion.

7. The battery cell of claim 6, wherein the one or more apertures are formed between the first and second fold regions.

8. The battery cell of claim 1, wherein the first terminal is a positive terminal.

9. The battery cell of claim 8, further comprising:
a second terminal coupled to the housing adjacent the second end:
a second formable conductor configured to electrically communicate current flow between the second terminal and the electrode assembly.

10. The battery cell of claim 1, wherein the first connector portion is folded about the first fold region by approximately 180 degrees with respect to the narrowed portion.

11. The battery cell of claim 10, wherein the second connector portion is folded about the second fold region by approximately 180 degrees with respect to the narrowed portion to form the conductor into an S-shape.

12. The battery cell of claim 1, wherein the narrowed portion includes a tapered portion connecting the first connector portion and the second connector portion.

13. The battery cell of claim 4, wherein a first length is defined between a terminating edge of the second connector portion and a center of the aperture,
a second length is defined between the terminating edge of the second connector portion and the second fold region,
a third length is defined between the first fold region and the second fold region, and
a fourth length is defined between the center of the aperture and the first fold region.

14. The battery cell of claim 13, wherein the third length is approximately half of the first length.

15. The battery cell of claim 13, wherein the fourth length is approximately equal to or greater than the second length.

16.-19. (canceled)

20. A method of connecting electrical elements of a battery cell, the method comprising:
positioning an electrode assembly within a housing of the battery cell;
rubbing the electrode assembly to create a rubbing portion;
connecting a first end of a formable conductor to the rubbing portion, the conductor including a body rated for a first amount of current flow;
narrowing a portion of the body to form a narrowed portion rated for a second amount of current flow that is less than the first amount;
folding the conductor in a first direction about a first fold region positioned on a first side of the narrowed portion;
folding the conductor in a second direction, toward the narrowed portion, about a second fold region positioned on a second side of the narrowed portion, such that the narrowed portion extends between the first and second fold regions; and
connecting a second end of the formable conductor to a terminal coupled to the housing,
wherein the narrowed portion is configured to interrupt current flow between the rubbing portion and the terminal in response to the current flow exceeding the second amount of current flow.

21. A battery cell comprising:
a housing including a first end and a second end opposite the first end:
a first terminal coupled to the housing adjacent the first end:
an electrode assembly positioned within the housing between the first end and the second end, the electrode assembly including an anode, a cathode, and one or more separator sheets, the electrode assembly further including a rubbing portion at a first end of one of the anode and the cathode; and
a formable conductor configured to electrically couple the rubbing portion and the first terminal, the conductor including:
a first connector portion coupled to the rubbing portion,
a second connector portion coupled to the first terminal,
a first fold region,
a second fold region, and
a fuse extending between the first and second fold regions,
wherein the first connector portion has a first dimension defining a first current rating, and the fuse has a second dimension defining a second current rating, and wherein the second dimension is less than the first dimension, and the second current rating is less than the first current rating.

22. The battery cell of claim 21, wherein the second connector portion has the first dimension.
